(19) United States
(12) Patent Application Publication
(10) Pub. No.: US 2020/0245067 A1
(43) Pub. Date: Jul. 30, 2020

(54) SPEAKER APPARATUS

(71) Applicant: DENSO TEN Limited, Kobe-shi (JP)

(72) Inventors: Takashi MORIKI, Kobe-shi (JP); Tomonori YAMAMOTO, Kobe-shi (JP); Keiichiro TANAKA, Kobe-shi (JP); Kiyosei SHIBATA, Kobe-shi (JP); Kunihiko IRIE, Kobe-shi (JP); Junji TABAYASHI, Kobe-shi (JP); Shinichiro ICHIKI, Kobe-shi (JP)

(73) Assignee: DENSO TEN Limited, Kobe-shi (JP)

(21) Appl. No.: 16/750,489

(22) Filed: Jan. 23, 2020

(30) Foreign Application Priority Data
Jan. 29, 2019 (JP) 2019-013496

(51) Int. Cl. H04R 5/02; H04R 1/02; H04R 1/28; H04R 1/34; H04S 1/00

(52) U.S. Cl. CPC H04R 5/02; H04R 1/025; H04R 1/288; H04R 2499/13; H04R 1/345; H04S 1/007; H04R 1/2811

(57) ABSTRACT

A speaker apparatus includes a pair of speakers and a connecting member. The pair of speakers is arranged in an interior of a structure protruding into an interior space of a vehicle. The pair of speakers has respective diaphragms facing the interior space of the vehicle and that are directed in opposite directions from each other. The pair of speakers has back surfaces that face each other. The connecting member inter-connects respective drivers of the pair of speakers and is connected to back surface sides of the drivers.

### BACKGROUND OF THE INVENTION

### Field of the Invention

The invention relates to a speaker apparatus.

### Description of the Background Art

Conventionally, various technologies for acoustic systems including a speaker apparatus that is mounted on a vehicle have been proposed. For example, on-vehicle acoustic video device proposed in Japanese Published Unexamined Patent Application No. 2001-270391 (Patent Document 1) employs a speaker installed in a driver's seat side door, a speaker installed in a passenger seat side door, a speaker installed in a rear tray, and a speaker installed in a front panel of a center console. As a result, a high-quality sound effect compatible with multichannel systems can be obtained.

However, in the conventional technology proposed in the Patent Document 1, for example, when a low-pitched sound is output from the speakers installed in the driver's seat side door and the passenger seat side door, since there is not enough acoustic space equivalent to a speaker enclosure in the interior of the doors, there is a problem that the sound quality deteriorates. Furthermore, since sufficient rigidity cannot be ensured in the installation area of the speakers in the vehicle, when a sound is output from the speakers, vibrations of the speakers are transmitted to the vehicle exterior sheet metal, etc., so that there is a concern that the vehicle exterior sheet metal, etc. vibrate to cause noise, or noise leakage occurs.

### SUMMARY OF THE INVENTION

According to one aspect of the invention, a speaker apparatus includes a pair of speakers and a connecting member. The pair of speakers is arranged in an interior of a structure protruding into an interior space of a vehicle. The pair of speakers has respective diaphragms facing the interior space of the vehicle and that are directed in opposite directions from each other. The pair of speakers has back surfaces that face each other. The connecting member inter-connects respective drivers of the pair of speakers and is connected to back surface sides of the drivers.

An object of the invention is to provide a technology capable of providing enough acoustic space in a speaker apparatus that is mounted on a vehicle, and effectively suppressing vibration transmission.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 is a partial plan view of a speaker apparatus according to an embodiment;

FIG. 2 is a plan view illustrating one example of a vehicle on which the speaker apparatus is mounted;

FIG. 3 is a perspective view illustrating a configuration example 1 of the speaker apparatus;

FIG. 4 is a perspective view illustrating a configuration example 2 of the speaker apparatus;

FIG. 5 is a perspective view illustrating a longitudinal section of the configuration example 2 of the speaker apparatus;

FIG. 6 is a perspective view illustrating a longitudinal section of a modification example of the configuration example 2 of the speaker apparatus;

FIG. 7 is a perspective view illustrating a configuration example 3 of the speaker apparatus 3;

FIG. 8 is a perspective view illustrating a longitudinal section of the configuration example 3 of the speaker apparatus;

FIG. 9 is a perspective view illustrating another member arranged in an interior of the speaker apparatus;

FIG. 10 illustrates a configuration example of a signal processing circuit of an acoustic signal that is input to the speaker apparatus;

FIG. 11 is a cross-sectional front view illustrating one example of a vehicle on which a modification example of the speaker apparatus is mounted; and

FIG. 12 is a cross-sectional side view illustrating one example of the vehicle on which the modification example of the speaker apparatus is mounted.

### DESCRIPTION OF THE EMBODIMENTS

An exemplified embodiment of the invention will be described below with reference to the drawings.

### 1. Basic Configuration of Speaker Apparatus

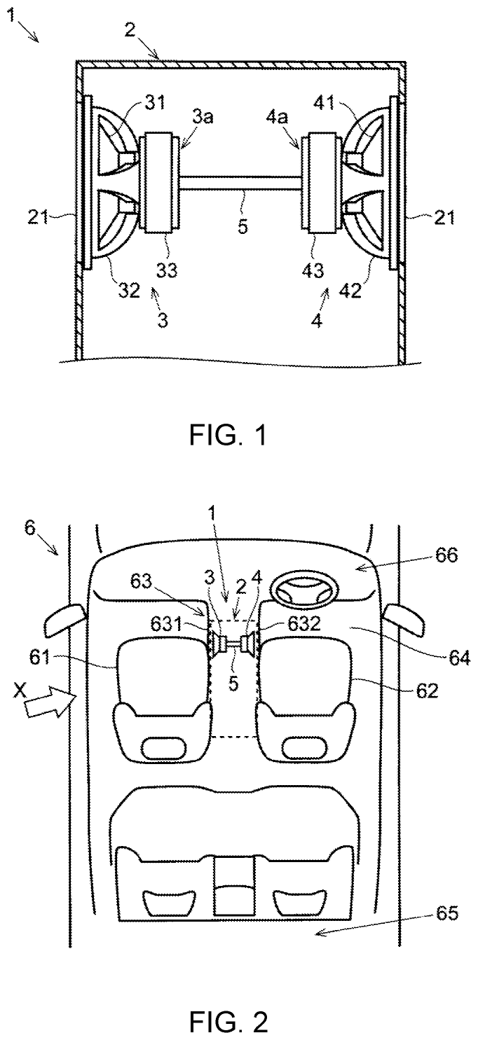

FIG. 1 is a partial plan view of a speaker apparatus 1 according to the embodiment. The speaker apparatus 1 includes an enclosure 2, a pair of a speaker 3 and a speaker 4, and a connecting member 5.

The enclosure 2 is a housing of the speaker apparatus 1 which has a substantially box shape. The enclosure 2 accommodates the pair of speakers 3 and 4, and the connecting member 5 inside. The enclosure 2 has openings 21 formed on respective left and right side walls thereof. The pair of speakers 3 and 4 is arranged in the left and right openings 21 of the enclosure 2, respectively.

The speakers 3 and 4 have a mutually same configuration. The speakers 3 and 4 respectively have frames 32 and 42 which contain diaphragms 31 and 41 (also called “cones”).

The speakers 3 and 4 are respectively fixed in the left and right openings 21 of the enclosure 2 via the frames 32 and 42. The diaphragms 31 and 41 are respectively arranged so that respective sound emitting directions of the speakers 3 and 4 are directed outward from the speaker apparatus 1 through the left and right openings 21. Drivers 33 and 43 are respectively arranged in positions opposite to the left and right openings 21 with respect to the diaphragms 31 and 41. The drivers 33 and 43 respectively include, for example, a voice coil, a magnetic circuit, terminals, and the like. The drivers 33 and 43 vibrate the diaphragms 31 and 41, according to an acoustic signal that is respectively input to the speakers 3 and 4.

The pair of speakers 3 and 4 respectively has the diaphragms 31 and 41 that are directed in opposite directions from each other and respective back surfaces 3a and 4a of the pair of speakers 3 and 4 face each other.

The connecting member 5 is arranged between the respective back surfaces 3a and 4a of the pair of speakers 3 and 4. The connecting member 5 inter-connects respective drivers 33 and 43 of the pair of speakers 3 and 4 and is connected to back surface sides of the drivers 33 and 43. The connecting member 5 may be made of, for example, an aluminum alloy, stainless steel, brass, or synthetic resins having high rigidity. It is desirable that the connecting member 5 be made of a material that sufficiently transmits vibration in a low frequency range and hardly transmits vibration in a high frequency range.

The connecting member may be constituted by combining a plurality of parts made of different materials instead of a single material to implement desirable transmission characteristics. The connecting member 5 has, for example, a substantially columnar shape that extends between the respective back surfaces 3a and 4a of the speakers 3 and 4. However, a radial direction size of the connecting member 5 may be partially different between the back surfaces 3a and 4a.

### 2. Configuration of Speaker Apparatus of Vehicle

### 2-1. Configuration Example 1 of Speaker Apparatus

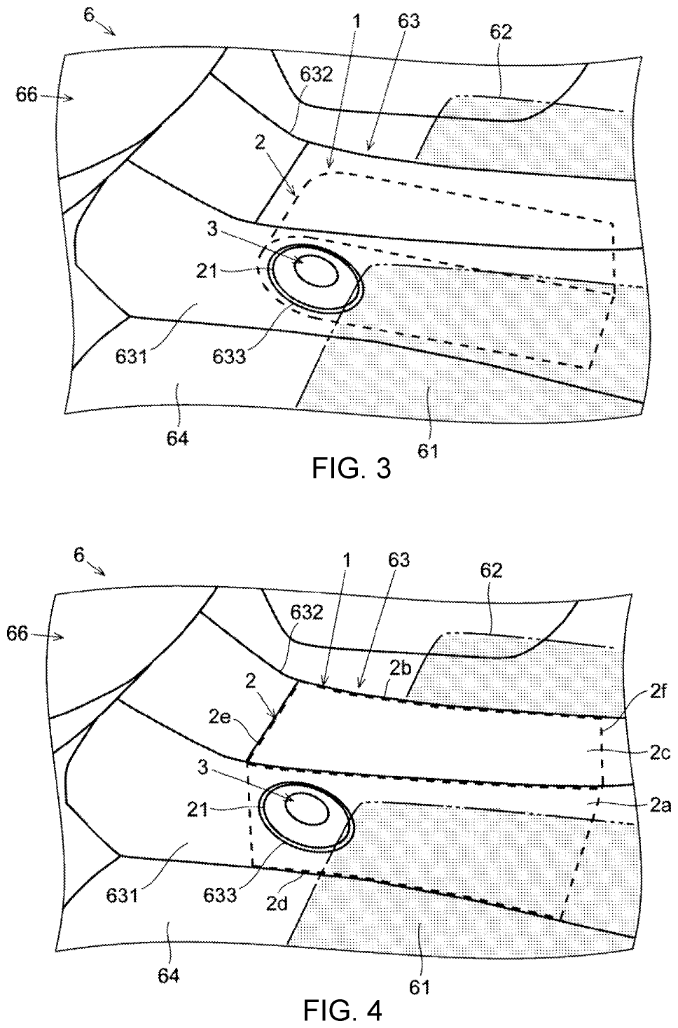

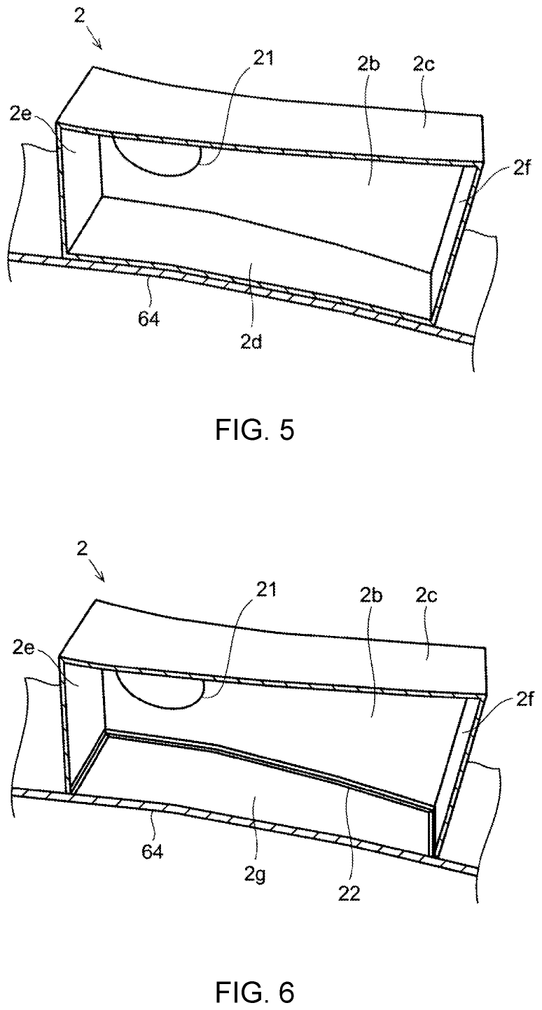

FIG. 2 is a plan view illustrating one example of a vehicle 6 on which the speaker apparatus 1 is mounted. FIG. 3 is a perspective view illustrating a configuration example 1 of the speaker apparatus 1. FIG. 3 illustrates an interior of the vehicle 6 viewed from a direction of an arrow X shown in FIG. 2. FIG. 3 shows a front part of a vehicle interior including a driver's seat 62 and a passenger seat 61 inside the vehicle 6. The same applies to FIG. 4 and FIG. 5 described later.

In the following description, an upper side direction in FIG. 2, which is a direction from the driver's seat 62 toward a steering wheel, is referred to as “front” of the vehicle 6. A lower side direction in FIG. 2, which is a direction from the steering wheel toward the driver's seat 62, is referred to as “rear” of the vehicle 6. A right side direction in FIG. 2, which is a direction from the passenger seat 61 toward the driver's seat 62, is referred to as “right”. A left side direction in FIG. 2, which is a direction from the driver's seat 62 toward the passenger seat 61, is referred to as “left”.

The speaker apparatus 1 is arranged in the interior of the vehicle 6 that is a type of vehicles. The vehicle 6 has a center console 63 between the passenger seat 61 and the driver's seat 62. The center console 63 is one of structures which are installed on a floor 64 of the vehicle 6 and protrude into an interior space of the vehicle 6. The center console 63 has a substantially box shape that is a substantially rectangular parallelepiped shape extending long and narrow in a longitudinal direction of the vehicle 6. The speaker apparatus 1 is arranged in an interior of the center console 63.

The enclosure 2 is arranged in the interior of the center console 63 of the vehicle 6. The enclosure 2 has a substantially box shape that is a substantially rectangular parallelepiped shape extending long and narrow in the longitudinal direction of the vehicle 6. In the configuration example 1 of this embodiment, the enclosure 2 is a housing that is positioned above the floor 64 of the vehicle 6 and arranged more inside than a housing of the center console 63.

The center console 63 has respective left and right side walls 631 and 632 having windows 633. The openings 21 of the enclosure 2 face the respective left and right side walls 631 and 632 of the center console 63. Specifically, the openings 21 of the enclosure 2 are arranged so as to be aligned with the windows 633 of the respective left and right side walls 631 and 632 of the center console 63, and exposed to the outside through the windows 633.

As described above, the pair of speakers 3 and 4 is arranged in the left and right openings 21, respectively. As a result, the respective diaphragms 31 and 41 (refer to FIG. 1) of the speakers 3 and 4 face the interior space of the vehicle 6. That is, the pair of speakers 3 and 4 respectively has the diaphragms 31 and 41 facing the interior space of the vehicle 6 that are directed in the opposite directions from each other, and the back surfaces 3a and 4a that are opposite to each other. In the speaker 3, the diaphragm 31 is directed toward a left side of the vehicle interior, i.e., a side of the passenger seat 61. In the speaker 4, the diaphragm 41 is directed toward a right side of the vehicle interior, i.e., a side of the driver's seat 62.

According to the above-mentioned configuration example 1, since the enclosure 2 is arranged in the interior of the center console 63 of the vehicle 6, an interior space of the center console 63 is used as an acoustic space of the enclosure 2. As a result, it is possible to provide enough acoustic space of the enclosure 2. Furthermore, by using the connecting member 5, vibrations respectively generated from the pair of speakers 3 and 4 cancel each other, so that it becomes possible to effectively suppress vibration transmission. Therefore, the vibrations do not transmit from the speaker apparatus 1 to the center console 63 and the floor 64 when a sound is emitted.

The speaker apparatus 1 is not necessarily arranged in the interior of the center console 63, and may be arranged in an interior of the structures protruding into the interior space of the vehicle 6, for example, such as a rear luggage room 65, an instrument panel 66, etc. shown in FIG. 2. According to this configuration, since the pair of speakers 3 and 4 whose back surfaces 3a and 4a face each other is arranged in the interior of the vehicle 6, it is possible to provide enough acoustic space equivalent to the enclosure. Furthermore, by using the connecting member 5, vibrations respectively generated from the pair of speakers 3 and 4 cancel each other, so that it becomes possible to effectively suppress vibration transmission.

### 2-2. Configuration Example 2 of Speaker Apparatus

FIG. 4 is a perspective view illustrating a configuration example 2 of the speaker apparatus 1. FIG. 5 is a perspective view illustrating a longitudinal section of the configuration example 2 of the speaker apparatus 1. The fundamental configuration of the configuration example 2 is the same as in the configuration example 1 described above. Accordingly, the same constituent elements are denoted with the same reference numerals or the same names, and an explanation about the configuration is omitted.

The enclosure 2 of the speaker apparatus 1 is arranged in the interior of the center console 63 of the vehicle 6. The enclosure 2 has a substantially box shape that is a substantially rectangular parallelepiped shape extending long and narrow in the longitudinal direction of the vehicle 6.

In the configuration example 2 of this embodiment, the enclosure 2 has a side wall 2a facing the side of the passenger seat 61, a side wall 2b facing the side of the driver's seat 62, and an upper surface 2c that is connected to respective upper ends of the side wall 2a and the side wall 2b in a width direction (left-right horizontal direction) of the vehicle 6. The enclosure 2 has a substantially same shape as the housing of the center console 63, and is positioned immediately inside the housing of the center console 63. The openings 21 of the enclosure 2 are arranged so as to be aligned with the windows 633 of the respective left and right side walls 631 and 632 of the center console 63, and exposed to the outside through the windows 633.

In the configuration example 2 of this embodiment, the enclosure 2 further has a lower surface 2d that is connected to respective lower ends of the side wall 2a and the side wall 2b in the width direction (left-right horizontal direction) of the vehicle 6. The lower surface 2d has a substantially same shape as a frame of the floor 64, and is positioned immediately above the frame of the floor 64. Front and rear surfaces of the enclosure 2 are closed by a front wall 2e and a rear wall 2f.

The side walls 2a and 2b and the upper surface 2c of the enclosure 2 may be configured by the housing itself of the center console 63. The lower surface 2d of the enclosure 2 may be configured by the frame itself of the floor 64.

According to the above-mentioned configuration example 2, at least a part of the enclosure 2 is configured by at least one of the housing of the center console 63 and the frame of the floor 64 of the vehicle 6. Therefore, it is possible to more effectively use the interior space of the center console 63 as the acoustic space of the enclosure 2. It is possible to reduce materials used for the enclosure 2. Furthermore, the shape of the enclosure 2 may be freely deformed. Even in such a configuration, it is possible to effectively use the interior space of the center console 63 as the acoustic space of the enclosure 2.

FIG. 6 is a perspective view illustrating a longitudinal section of a modification example of the configuration example 2 of the speaker apparatus. According to the modification example of this configuration example 2, the enclosure 2 is configured in a box shape having an opening 2g in a bottom. That is, the enclosure 2 shown in FIG. 6 does not have the lower surface 2d shown in FIG. 5. The enclosure 2 is arranged on the floor 64 of the vehicle 6 so that the floor 64 closes the opening 2g in the bottom of the enclosure 2. Furthermore, the speaker apparatus 1 includes a sealing part 22 between the opening 2g in the bottom of the enclosure 2 and the floor 64 of the vehicle 6. The sealing part 22 is provided around an entire periphery of the opening 2g in the bottom of the enclosure 2 to seal the entire periphery of the opening 2g.

According to the modification example of the above-mentioned configuration example 2, when the housing of the center console 63 and the frame of the floor 64 of the vehicle 6 are used as the enclosure 2, a sealed type enclosure is prepared only by a simple process in which the enclosure 2 is positioned on the floor 64 while interposing the sealing part 22, and fixed by screws, etc. As a result, it is possible to prevent the sound in an interior of the enclosure 2 from leaking outside. Therefore, the speaker apparatus 1 can obtain a high-quality acoustic effect. Furthermore, since special skills and many man-hours are not required to assemble the speaker apparatus 1, the speaker apparatus 1 is preferably assembled, particularly in vehicle manufacturers, and the like.

### 2-3. Configuration Example 3 of Speaker Apparatus

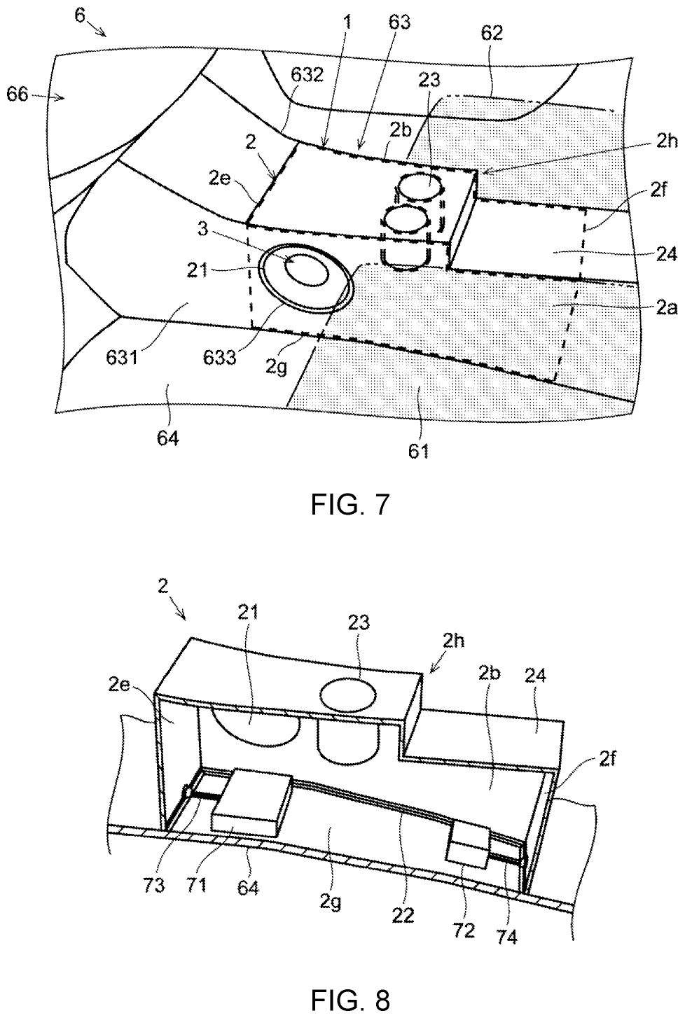

FIG. 7 is a perspective view illustrating a configuration example 3 of the speaker apparatus 1. FIG. 8 is a perspective view illustrating a longitudinal section of the configuration example 3 of the speaker apparatus 1. The fundamental configuration of the configuration example 3 is the same as in the configuration example 2 described above. Accordingly, the same constituent elements are denoted with the same reference numerals or the same names, and an explanation about the configuration is omitted.

The enclosure 2 of the speaker apparatus 1 is arranged in the interior of the center console 63 of the vehicle 6. The enclosure 2 has a substantially box shape that is a substantially rectangular parallelepiped shape extending long and narrow in the longitudinal direction of the vehicle 6.

In the configuration example 3 of this embodiment, the enclosure 2 has the side wall 2a facing the side of the passenger seat 61, the side wall 2b facing the side of the driver's seat 62, and an upper surface 2h that is connected to respective upper ends of the side wall 2a and the side wall 2b in the width direction (left-right horizontal direction) of the vehicle 6. The side walls 2a and 2b and the upper surface 2h of the enclosure 2 are configured by the housing itself of the center console 63. Furthermore, in the configuration example 3 of this embodiment, the lower surface of the enclosure 2 is configured by the frame itself of the floor 64 of the vehicle 6. The sealing part 22 is provided around the entire periphery of the opening 2g in the bottom of the enclosure 2 to seal the entire periphery of the opening 2g. The front and rear surfaces of the enclosure 2 are closed by the front wall 2e and the rear wall 2f.

The upper surface 2h of the enclosure 2 has cup holders 23 and a step 24. For example, there are two cup holders 23 that are horizontally aligned with each other. One of the two cup holders 23 is arranged on the side of the passenger seat 61 and the other one is arranged on the side of the driver's seat 62. Each of the cup holders 23 has a cylindrical recessed shape with a bottom and is recessed downward from the upper surface 2h toward the interior of the enclosure 2. The step 24 is, for example, arranged on a rear side of the cup holders 23. The step 24 is recessed downward from the highest surface, that is, the upper surface 2h on which flanges of the cup holders 23 are provided.

The cup holders 23 and the step 24 are not limited to the above-mentioned configuration. For example, a number of the cup holders 23 is not limited to two, but may be, for example, one or three or more. The shape of each of the cup holders is not limited to a cylindrical shape, but may be a rectangular tubular shape. Furthermore, the step 24 may be configured to protrude upward. The side walls 2a and 2b may be configured to have a concave and convex shape. Besides the cup holders, a storage box, an ashtray, and the like, may be provided on the upper surface 2h of the enclosure 2.

As described above, the enclosure 2 may have various functional structures and decorative structures. Even in such a configuration, it is possible to effectively use the interior space of the center console 63 as the acoustic space of the enclosure 2.

In the configuration example 3 of this embodiment, electronic control units (ECUs) 71 and 72 and harnesses 73 and 74 are arranged in the interior of the enclosure 2. The ECUs 71 and 72 and harnesses 73 and 74 are other members other than the pair of speakers 3 and 4, and the connecting member 5. The ECUs 71 and 72 are included in the enclosure 2. The harnesses 73 and 74 are electric wires that perform transmission and reception of electric power and signals with respect to each of the ECUs 71 and 72. The harness 73 passes through, for example, a front wall 2e of the enclosure 2. The harness 74 passes through, for example, a rear wall 2f of the enclosure 2. A through part of the front wall 2e of the harness 73 and a through part of the rear wall 2f of the harness 74 are sealed with the sealing part 22.

As other members other than the components of the speaker apparatus 1, other members other than ECUs and harnesses, for example, a switch, a duct, and the like, may be arranged in the interior of the enclosure 2. According to this configuration, devices and members such as the ECUs 71 and 72 and the harnesses 73 and 74 may be arbitrarily arranged in the interior of the enclosure 2. Then, it is possible to effectively use the interior space of the center console 63 as the acoustic space of the enclosure 2.

As illustrated in FIG. 6, if a box-shape configuration having the opening 2g in a bottom is adopted for the enclosure 2, a sealed-type enclosure including the ECUs and harnesses, etc. is prepared only by a simple process in which the ECUs 71 and 72 and the harnesses 73 and 74, etc. are arranged on the floor 64 in advance, the enclosure 2 is positioned on the floor 64 while interposing the sealing part 22, and fixed by screws, etc. As a result, since special skills and many man-hours are not required to assemble the speaker apparatus 1, the speaker apparatus 1 is preferably assembled, particularly in vehicle manufacturers, and the like.

The enclosure 2 contains an electromagnetic wave shielding material. For example, the enclosure 2 is configured as a metal housing, applied with plating or coating having an electromagnetic wave shielding effect, provided with a conductive fiber, or the like, so that the enclosure 2 contains the electromagnetic wave shielding material. According to this configuration, by using the enclosure 2, it becomes possible to prevent electromagnetic waves from going out of and coming into the enclosure 2. That is, by using the enclosure 2, it is possible to take countermeasures against electromagnetic wave disturbance.

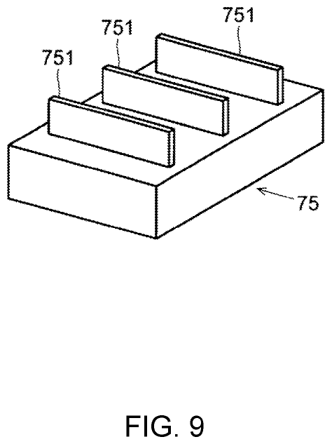

FIG. 9 is a perspective view illustrating another member (an ECU 75) arranged in an interior of the speaker apparatus 1. The ECU 75 is another member other than the pair of speakers 3 and 4, and the connecting member 5. A sound wave absorber/scatterer 751 for absorbing/scattering sound waves is provided on an outer periphery of the ECU 75. In the configuration example 3 of this embodiment, the sound wave absorber/scatterer 751 is, for example, configured of a plurality of acoustic fins. The plurality of the acoustic fins of the sound wave absorber/scatterer 751 is arranged on the outer periphery of the ECU 75, and protrudes outside from the outer periphery of the ECU 75. The sound wave absorber/scatterer 751 does not necessarily have a concave and convex part such as the acoustic fins, and for example, a sound absorbing material may cover the outer periphery of the ECU 75. According to this configuration, it is possible to prevent the sound in the interior of the enclosure 2 from affecting other members to be arranged in the interior of the speaker apparatus 1. Furthermore, it is possible to appropriately adjust acoustic characteristics of the interior of the enclosure 2.

### 2-4. Configuration Example of Signal Processing Circuit of Acoustic Signal

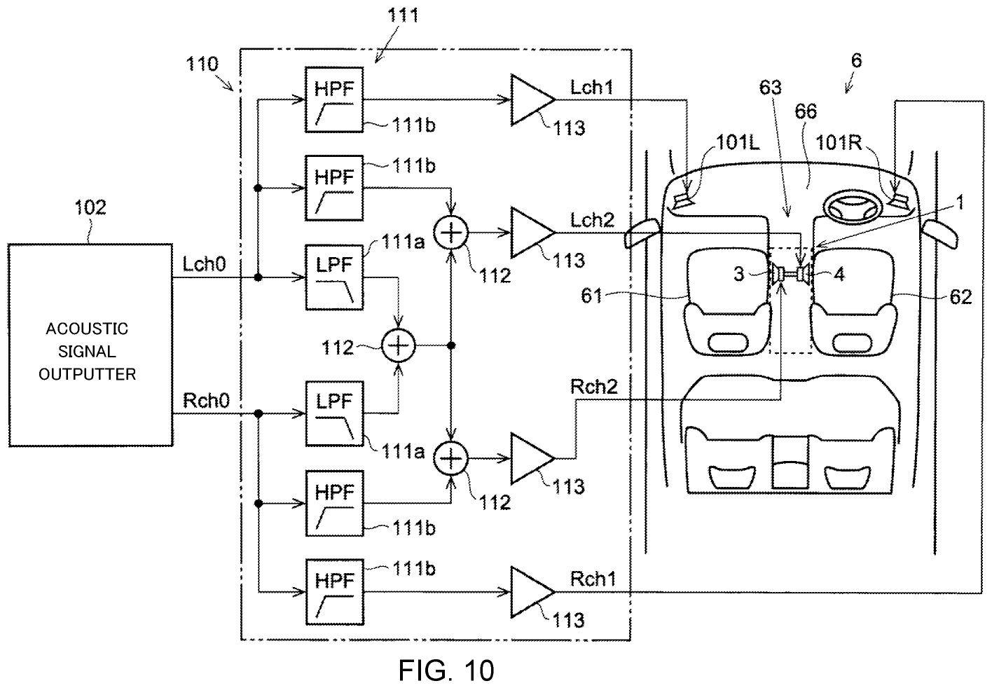

FIG. 10 illustrates a configuration example of a signal processing circuit of an acoustic signal that is input to the speaker apparatus 1. The vehicle 6 has a front speaker 101L, a front speaker 101R, an acoustic signal outputter 102, and a signal processing circuit 110 in addition to the speaker apparatus 1.

The speaker apparatus 1 is arranged in the interior of the center console 63 of the vehicle 6. The speaker 3 is directed toward a left side of the vehicle 6, that is, the side of the passenger seat 61. The speaker 4 is directed toward a right side of the vehicle 6, that is, the side of the driver's seat 62. The speaker apparatus 1 is electrically connected to the signal processing circuit 110.

The front speakers 101L and 101R are arranged above or below the instrument panel 66. The front speaker 101L is arranged at a left end of the instrument panel 66. The front speaker 101R is arranged at a right end of the instrument panel 66. The front speakers 101L and 101R are electrically connected to the signal processing circuit 110.

The acoustic signal outputter 102 is, for example, included in an in-vehicle audio apparatus, and the like. The acoustic signal outputter 102 is electrically connected to the signal processing circuit 110. The acoustic signal outputter 102 outputs an acoustic signal that is emitted from the speaker apparatus 1 and the front speakers 101L and 101R via the signal processing circuit 110. The acoustic signal outputter 102 outputs a left channel signal Lch0 and a right channel signal Rch0 of the acoustic signal.

The signal processing circuit 110 executes various signal processing for the acoustic signal input from the acoustic signal outputter 102, and outputs the processed acoustic signal to the speaker apparatus 1 and the front speakers 101L and 101R. The signal processing circuit 110 includes a filter 111, an adder 112, and an amplifier 113.

The filter attenuates frequency components other than a frequency component in a predetermined band of the acoustic signal input from the acoustic signal outputter 102, and passes a frequency component in the predetermined band. The filter 111 includes a low pass filer 111a and a high pass filter 111b. The low pass filter 111a attenuates a frequency component in a band equal to or higher than the predetermined band of the acoustic signal input from the acoustic signal outputter 102, and passes a frequency component in a band lower than the predetermined band. The high pass filter 111b attenuates a frequency component in a band equal to or lower than the predetermined band of the acoustic signal input from the acoustic signal outputter 102, and passes a frequency component in a band higher than the predetermined band.

The adders 112 add acoustic signals input from the respective low and high pass filters 111a and 111b, and output the resulting acoustic signals to the amplifiers 113.

The amplifiers 113 amplify the acoustic signals input from the filters 111 or the adders 112, and output the amplified acoustic signals to the speaker apparatus 1 and the front speakers 101L and 101R.

A left channel signal Lch1 of the acoustic signal is input to the front speaker 101L. The left channel signal Lch1 of the front speaker 101L is the left channel signal Lch0 output from the acoustic signal outputter 102 and having a frequency component in a band higher than the predetermined band, which is passed through the high pass filter 111b, further amplified by the amplifier 113 and input to the front speaker 110L.

A right channel signal Rch1 of the acoustic signal is input to the front speaker 101R. The right channel signal Rch1 of the front speaker 101R is the right channel signal Rch0 output from the acoustic signal outputter 102 and having a frequency component in a band higher than the predetermined band, which is passed through the high pass filter 111b, further amplified by the amplifier 113 and input to the front speaker 110R.

In the speaker apparatus 1, a right channel signal Rch2 of the acoustic signal is input to the speaker 3 that is directed toward the side of the passenger seat 61. A left channel signal Lch2 of the acoustic signal is input to the speaker 4 that is directed toward the side of the driver's seat 62.

Here, the left channel signal Lch0 and the right channel signal Rch0 that have been output from the acoustic signal outputter 102 and have respective frequency components in a band lower than the predetermined band allowed to pass through the low pass filter 111a are added by the adder 112.

The right channel signal Rch2 of the speaker 3 of the speaker apparatus 1 includes the right channel signal Rch0 output from the acoustic signal outputter 102 and having a frequency component in a band higher than the predetermined band allowed to pass through the high pass filter 111b, and the left channel signal Lch0 and the right channel signal Rch0 having the respective frequency components in a band lower than the predetermined band allowed to pass through the low pass filter 111a, which are further added by the adder 112, amplified by the amplifier 113, and input to the speaker 3.

The left channel signal Lch2 of the speaker 4 of the speaker apparatus 1 includes the left channel signal Lch0 output from the acoustic signal outputter 102 and having a frequency component in a band higher than the predetermined band allowed to pass through the high pass filter 111b, and the left channel signal Lch0 and the right channel signal Rch0 having the respective frequency components in a band lower than the predetermined band allowed to pass through the low pass filter 111a, which are further added by the adder 112, amplified by the amplifier 113, and input to the speaker 4.

According to the above-mentioned configuration, sound source signals of the right channel signal Rch2 and the left channel signal Lch2 are input to the pair of speakers 3 and 4, respectively. According to this configuration, by using the pair of speakers 3 and 4, it is possible to obtain a stereo acoustic effect by effectively utilizing the interior space of the vehicle 6.

According to the above-mentioned configuration, in the pair of speakers 3 and 4, in-phase monaural source signals are input in a low-pitched sound range and stereo source signals are input in a high-pitched sound range. According to this configuration, the pair of speakers 3 and 4 of the speaker apparatus 1 can serve as both a stereo and a subwoofer (0.1ch). Therefore, it is possible to reduce a number of speakers to be mounted and effectively utilize the interior space of the vehicle 6.

### 3. Others, Modification Example

In addition to the foregoing embodiments, various technological features disclosed in this specification can be changed without departing from the spirit of the technical invention. In other words, the foregoing embodiments are examples in every aspect, and do not intend to limit the invention. The scope of the invention will be defined by the scope of claims, not by the description in the foregoing embodiments. The scope of the claims should include the scope of claims, equivalents thereof and all changes within the scope. Features of the above-described preferred embodiments and the modifications thereof may be combined appropriately as long as no conflict arises.

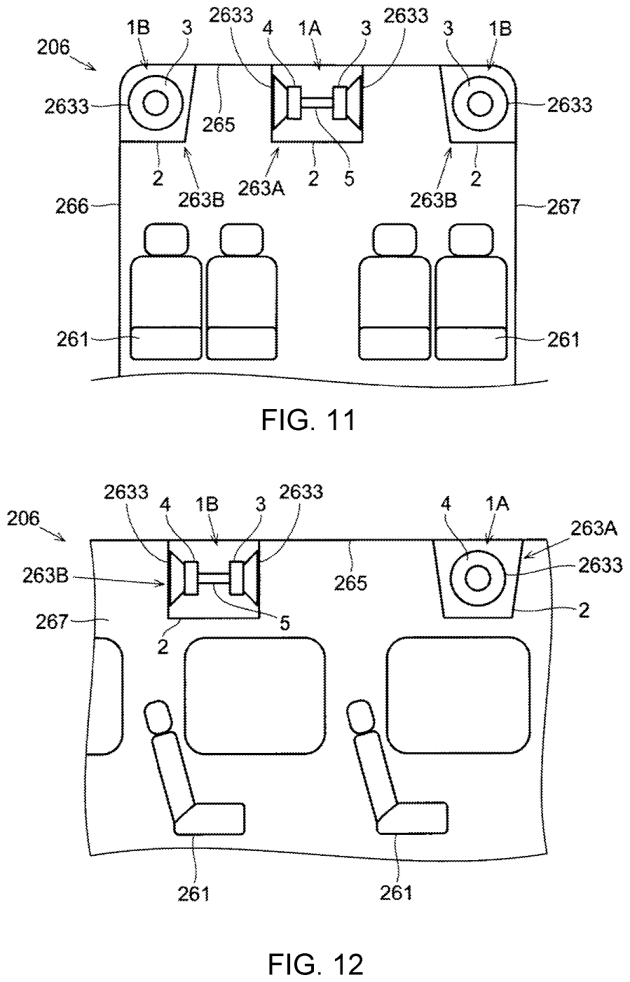

FIG. 11 is a cross-sectional front view illustrating one example of a vehicle 206 on which a modification of the speaker apparatus is mounted. FIG. 12 is a cross-sectional side view illustrating one example of the vehicle 206 on which the modification of the speaker apparatus is mounted. FIG. 11 is a cross-section of the vehicle 206, viewed from a front side to a rear side of the vehicle 206. FIG. 12 is a cross-section of the vehicle 206, viewed from a right side to a left side of the vehicle 206. A right side in FIG. 12 is the front side of the vehicle 206, and a left side in FIG. 12 is the rear side of the vehicle 206.

A speaker apparatus 1A and speaker apparatuses 1B of the modification example of the embodiment are arranged in an interior of the vehicle 206 including, for example, busses, railroad vehicles, airplanes, ships, etc. That is, the speaker apparatus 1A and the speaker apparatuses 1B of the modification example of the embodiment may be arranged in interiors of structures protruding into an interior space of the vehicle 206 including, for example, busses, railroad vehicles, airplanes, ships, etc. in addition to a passenger car such as the vehicle 6.

The fundamental configuration of the modification example is the same as in the configuration example 1, and the like, described above. Accordingly, the same constituent elements are denoted with the same reference numerals or the same names, and an explanation about the configuration is omitted.

The speaker apparatus 1A and the speaker apparatuses 1B are arranged in interiors of a structure 263A and structures 263B each protruding into the interior space of the vehicle 206. The structure 263A and the structures 263B are arranged, for example, above seats 261 and on a ceiling 265 of the vehicle 206. That is, the speaker apparatus 1A and the speaker apparatuses 1B are arranged on the ceiling 265 of the vehicle 206.

As illustrated in FIG. 11, the structure 263A inside which the speaker apparatus 1A is arranged is positioned, for example, in a center in a width direction (left-right horizontal direction) of the vehicle 206. A pair of speakers 3 and 4 of the speaker apparatus 1A is arranged so as to be aligned with windows 2633 of respective left and right side walls of the structure 263A, and is directed in opposite directions from each other in the left-right horizontal direction of the vehicle 206.

As illustrated in FIG. 11, the structures 263B inside which the speaker apparatuses 1B are respectively arranged are positioned, for example, at both ends of the width direction (left-right horizontal direction) of the vehicle 206, and adjacent to respective left and right side walls 266, 267 of the vehicle 206. A pair of speakers 3 and 4 of each of the speaker apparatuses 1B is arranged so as to be aligned with windows 2633 of respective front and rear side walls of each of the structures 263B, and is directed in opposite directions from each other in a longitudinal direction of the vehicle 206.

As shown in the configuration of the above-mentioned modification example, in the pair of speakers 3 and 4 of each of the speaker apparatus 1A and the speaker apparatuses 1B, sound emitting directions may be directed not only in the left-right horizontal direction of the vehicle 206, but also in the longitudinal direction of the vehicle 206. Furthermore, although not shown in the drawing, the sound emitting directions of the speaker apparatus of the invention may be directed in a vertical direction. Moreover, as shown in the configuration of the above-mentioned modification example, the speaker apparatus of the invention may be installed not only on the floor of the vehicle but also on the ceiling and side walls of the vehicle. In addition, the speaker apparatus of the invention may be installed on the floor and side walls, etc. of the vehicle without a roof (ceiling).

While the invention has been shown and described in detail, the foregoing description is in all aspects illustrative and not restrictive. It is therefore understood that numerous other modifications and variations can be devised without departing from the scope of the invention.

What is claimed is:

1. A speaker apparatus comprising:
a pair of speakers that is arranged in an interior of a structure protruding into an interior space of a vehicle, the pair of speakers having respective diaphragms facing the interior space of the vehicle and that are directed in opposite directions from each other, the pair of speakers having back surfaces that face each other; and
a connecting member that inter-connects respective drivers of the pair of speakers and is connected to back surface sides of the drivers.

2. The speaker apparatus according to claim 1, further comprising:
an enclosure that is arranged in an interior of a center console of the vehicle, the enclosure having openings that face respective left and right side walls of the center console;
wherein the pair of speakers is arranged in respective left and right openings of the enclosure.

3. The speaker apparatus according to claim 2, wherein
another member other than the pair of speakers and the connecting member is arranged in an interior of the enclosure.

4. The speaker apparatus according to claim 3, wherein
the enclosure contains an electromagnetic wave shielding material.

5. The speaker apparatus according to claim 3, wherein
a sound wave absorber/scatterer for absorbing/scattering sound waves is provided on an outer periphery of the another member in the interior of the enclosure.

6. The speaker apparatus according to claim 2, wherein
at least a part of the enclosure is configured by at least one of a housing of the center console and a frame of a floor of the vehicle.

7. The speaker apparatus according to claim 2, wherein
the enclosure is configured in a box shape having an opening in a bottom and is arranged on a floor of the vehicle so that the floor closes the opening in the bottom of the enclosure, and a sealing part is interposed between the opening in the bottom of the enclosure and the floor.

8. The speaker apparatus according to claim 1, wherein
the pair of speakers includes inputs by which sound source signals of a right channel signal and a left channel signal are input to the pair of speakers, respectively.

9. The speaker apparatus according to claim 1, wherein
the pair of speakers includes inputs by which in-phase monaural source signals are input in a low-pitched sound range and stereo source signals are input in a high-pitched sound range.
